(19) United States
(12) Patent Application Publication
(10) Pub. No.: US 2003/0043754 A1
(43) Pub. Date: Mar. 6, 2003

(54) Network test system having multiple screen graphical user interface

(76) Inventors: Richard J. Brody, Clinton, MA (US); John P. Fitzgerald, Holden, MA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/941,258

(22) Filed: Aug. 28, 2001

(51) Int. Cl. H04J 1/16

(52) U.S. Cl. 370/252; 370/241

(57) ABSTRACT

A network test device, comprising a base unit including at least one modular location to receive a test module, at least one test module coupled to the base unit and configured to provide access to a communication link, and a display configured to display at least two communication link parameters simultaneously allows testing and display of multiple parameters of one or more communication links simultaneously.

### BACKGROUND OF THE INVENTION

As communication networks become more and more complex and capable of providing more and more services, the need for testing, troubleshooting, and determining the operating characteristics of these services becomes increasingly more important. For example, the ability to quickly and accurately determine the performance characteristics of a synchronous optical network (SONET) connection between two communication company's central office locations is becoming increasingly more important as more and more services are provided over SONET connections. A typical SONET connection transfers data and voice information at speeds in the gigabit/second range and includes many different service offerings. Further, a SONET connection includes both optical parameters and electrical parameters.

Conventional test devices are capable of testing only one of the parameters of such a SONET connection at a time. For example, conventional test devices may test only the optical or electrical parameters at any one moment. If the OC-3 layer in a SONET connection is under test, then existing devices cannot simultaneously analyze the separate DS-3 layer. Further, conventional network test devices are capable of testing only one SONET connection at a time and only one of the many different services provided on such a SONET connection. Unfortunately, this arrangement requires multiple test devices to test more than one parameter of a communication line and requires more than one test device to test all the services available on such a communication line.

Another drawback of existing network test devices is that there will be a different (although similar in appearance) graphical user interface (GUI) provided to the user of the multiple network test devices. Although similar in appearance, these multiple GUI's will not be linked so as to provide a common GUI for the multiple communication lines/services under test.

Therefore, it would be desirable to have a network test device that is capable of testing more than one communication line and more than one service provided on a single communication line simultaneously, while providing a common GUI for each of the communication lines and services under test.

### SUMMARY

The invention includes a network test device, comprising a base unit including at least one modular location to receive a test module, at least one test module coupled to the base unit and configured to provide access to a communication link, and a display configured to display at least two communication link parameters simultaneously.

### BRIEF DESCRIPTION OF THE DRAWINGS

The invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplar communication environment in which the network test device of the invention resides.

FIG. 2 is a block diagram illustrating an exemplar network test device constructed in accordance with an embodiment of the invention.

FIG. 3 is a flow chart illustrating the operation of particular aspects of the invention.

FIG. 4 is a graphical illustration showing the graphical user interface (GUI) presented to a user of the test device in which two different parameters are displayed for one communication line on the display using different screens, or panels.

FIG. 5 is a graphical illustration showing the graphical user interface presented to a user of the test device in which the same parameter for two different communication links is simultaneously displayed to a user.

### DETAILED DESCRIPTION OF TIE PREFERRED EMBODIMENT

The network test system having a multiple screen graphical user interface can be implemented in software (e.g., firmware), hardware, or a combination thereof. In one embodiment, the network test system having a multiple screen graphical user interface is implemented using a dedicated test platform having a dedicated processor. However, regardless of the manner of implementation, the software portion of the invention can be executed by a special or general purpose computer, such as a personal computer (PC; IBM-compatible, Apple-compatible, or otherwise), workstation, minicomputer, or mainframe computer. Furthermore, the invention may be implemented in other processing or computing devices, such as, for example but not limited to, a palmtop computer, a personal data assistant (PDA), or any other piece of network test equipment etc.

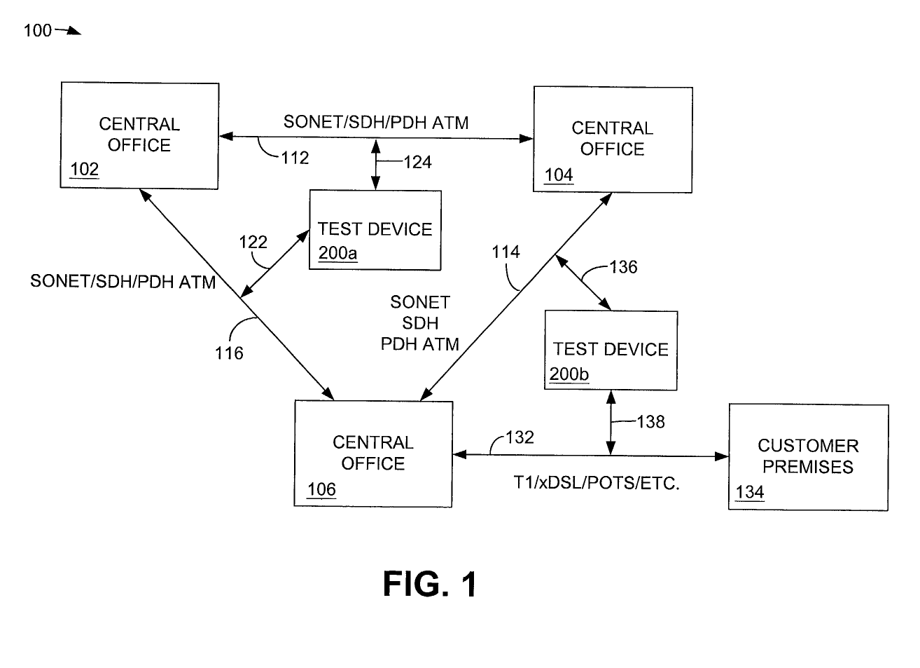

FIG. 1 is a schematic view illustrating an exemplar communication environment 100 in which the invention resides. The communication environment 100 includes a plurality of telephone company (TELCO) locations that each have one or more central office locations, exemplar ones of which are illustrated using reference numerals 102, 104 and 106. Each central office location is connected to another central office location via a synchronous optical network (SONET) ring. For example, central office 102 is connected to central office 104 using SONET ring 112, central office 102 is connected to central office 106 using SONET ring 116 and central office 104 is connected to central office 106 using SONET ring 114. Further, although illustrated in FIG. 1 as coupled to two other central office locations, each central office location may be coupled to fewer or more central office locations.

Each SONET ring 112, 114 and 116 implements a communication protocol referred to in the U.S. as synchronous optical network, and referred to elsewhere as synchronous digital hierarchy (SDH). Further, each SONET ring supports a number of different service offerings, such as plesiochronous digital hierarchy (PDH), DS-0, DS-1 and DS-3 in North America, and E-1 and E-3 elsewhere. Further still, each SONET ring may also support asynchronous transfer mode (ATM) communication. As known to those having ordinary skill in the art, the SONET rings that connect the central offices are high-speed optical communication backbones that typically comprise one or more optical fibers, running one or more high-speed communication links. For example, each SONET ring can provide DS-1/DS-3 and E-1/E-3 communication service functionality. Further, as known to those having ordinary skill in the art, each SONET ring can support various combinations of voice, telephony and data exchange. Further still, each communication link within each SONET ring includes optical characteristics and electrical characteristics each having particular operating parameters. These optical and electrical characteristics and operating parameters define the operation of and define the service provided by each of the SONET rings.

In addition to the central office locations, FIG. 1 also includes a customer premises location 134 coupled to central office 106 via communication line 132. Communication line 132 can be any communication link capable for connecting a central office to a customer premises location. For example, communication line 132 may comprises a copper wire pair that supports, for example but not limited to, dial-up modem communication, various permutations of digital subscriber line (DSL) communications, hereafter referred to as xDSL, plain old telephone service (POTS), T1, fractional T1, or any other communication service that is typically provisioned from a central office location to a customer premises location. The customer premises may be a residential location or a business location.

Periodically, it is desirable to test the various communication links that comprise the communication environment 100. For example, during set up and while performing maintenance operations it is desirable to test and verify the functionality of each of the SONET rings 112, 114 and 116. Furthermore, it is also desirable to test and, if necessary, troubleshoot the communication line 132 that runs between the central office 106 and the customer premises 134. In the past, such testing was typically accomplished by a single test device connected to one of the communication lines. For example, a test device might be connected to one of the SONET rings 112, 114 or 116 in order to test the various parameters thereof

In accordance with an aspect of the invention, a test device 200 constructed in accordance with embodiments of the invention can be connected to one of the communication links shown in FIG. 1 and test two or more parameters of the communication link to which the test device 200 is connected. Alternatively, a test device 200 constructed in accordance with embodiments of the invention can be connected simultaneously to two of the communication links. For example, a test device 200a can be coupled to SONET rings 112 and 116 via connections 124 and 122, respectively, or test device 200b can be coupled to one of the SONET rings via connection 136 and to the communication line 132 via connection 138. The connections 122, 124, 136 and 138 can be any connections that allow a test device to be coupled to communications lines 112, 114, 116 and 138. In accordance with embodiments of the invention to be described below, each test device 200a and 200b can test and display to a user, on a multiple panel interactive liquid crystal display (LCD), multiple parameters of a single communication line, the same parameter of multiple communication lines, or multiple parameters of multiple communication lines.

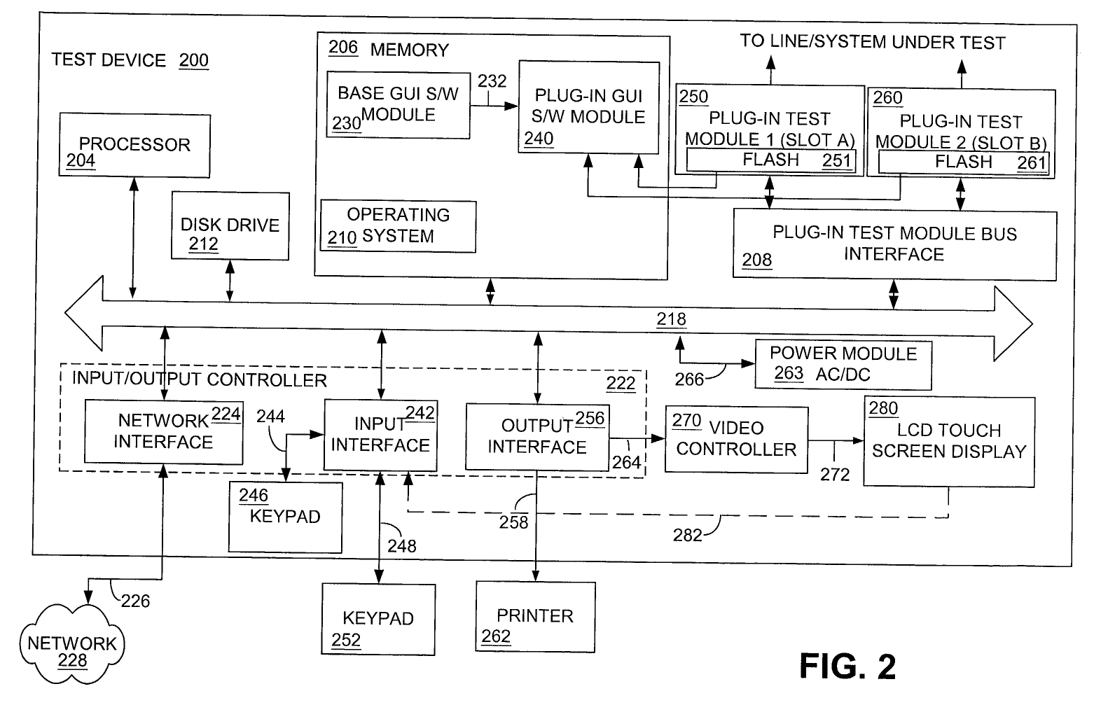

FIG. 2 is a block diagram illustrating an exemplar network test device 200 constructed in accordance with an embodiment of the invention. The test device 200, which can be thought of as a base unit, includes a memory 206, which includes software in the form of a base GUI software module 230 and a plug-in GUI software module 240. The software modules 230 and 240, along with other software and hardware elements (to be discussed below), work in unison to implement the functionality of the invention. Generally, in terms of hardware architecture, as shown in FIG. 2, the test device 200 includes a processor 204, memory 206 (one or more random access memory (RAM) elements, read only memory (ROM) elements, etc.), an optional removable media disk drive 212, a plug-in test module bus interface 208, referred to below as a “bus interface,” an input/output controller 222 and a power module 263 that are connected together and can communicate with each other via a local interface 218. The local interface 218 can be, for example but not limited to, one or more buses or other wired or wireless connections, as is known to those having ordinary skill in the art. The local interface 218 may have additional elements, which are omitted for simplicity, such as buffers (caches), drivers, and controllers, to enable communications. Further, the local interface 218 includes address, control, and data connections to enable appropriate communications among the aforementioned components.

The input/output controller 222 includes a network interface 224, an input interface 242 and an output interface 256 each in communication with the local interface 218. The network interface 224 couples the test device 200 to an external network 228 via connection 226. The external network can be any network to which the test device 200 may couple to exchange information. The input interface 242 is coupled to an internal keypad 246 via connection 244 and to an external keypad 252 via connection 248. The internal keypad 246 is located on the test device 200 while the external keypad 252 is an auxiliary keypad to which the test device 200 may be coupled.

The output interface 256 is coupled to a printer 262 via connection 258. The printer 262 can be used to provide a permanent record of the test results obtained by the test device 200. The output interface 256 also couples to a video controller 270 via connection 264. The video controller 270 couples to a touch-screen display 280 via connection 272. Preferably, the display 280 is an LCD touch screen display capable of receiving input from a user, but may be any type of suitable display. In accordance with particular embodiments of the invention, the display 280 provides to a user of the test device 200 multiple panes, or displays, thereby displaying multiple communication line parameters simultaneously. For example, the display 280 can be used to display multiple parameters of the same communication line, the same parameter of multiple communication lines, or multiple parameters of multiple communication lines. Because the display 280 functions as a “touch screen” display that provides an interactive user interface, it is depicted in FIG. 2 as providing an input to the input interface 242 via connection 282. The disk drive 212 can be any storage element or memory device, and as used herein, generally refers to flash memory, sometimes referred to as compact flash (CF) or PC-card.

The power module 263 can power the test device 200 from an AC power source, or can include batteries and a built in charger to provide portable DC power.

The plug-in test module bus interface 208 provides both electrical and mechanical interfaces to the plug-in test modules. In one embodiment, the test device 200 includes the capability to house two plug-in test modules 250 and 260 in what are referred to as slots “A” and “B”, respectively. In accordance with an aspect of the invention, each of the plug-in test modules 250 and 260 can interface to and provide testing and diagnostic functionality for one or more communication lines. For example, one plug-in test module can test one or more parameters of the SONET communication lines 112, 114 and 116 while another plug-in test module can test one or more parameters of the communication line 132 of FIG. 1. Each of the plug-in test modules 250 and 260 interfaces to one of the lines or systems under test and includes the capability for testing a particular type of service on a communication link.

The plug-in test module 250 includes a flash memory component 251 and the plug-in test module 260 includes a flash memory component 261. The flash memory components 251 and 261 include specific operating software (in the form of application software) for a respective plug-in GUI test module 250 and 260 and is loaded into the memory 206 (and more specifically, forms a component of the plug-in GUI software module 240) when the plug-in GUI test module is inserted into the bus interface 208. The flash memory components 251 and 261 include the software that defines the “personality” of the respective plug-in module and enables the particular functionality of the respective plug-in GUI test module. When two plug-in modules 250 and 260 are operating, the plug-in GUI software module 240 executes both the flash memory component 251 and the flash memory component 261. In possible alternative implementations, the application software that is contained in the flash memory component 251 and the flash memory component 261 may be contained in the test device 200 and executed when the plug-in module 250 and/or the plug-in module 260 is installed in the test device 200.

The processor 204 is a hardware device for executing software that can be stored in memory 206. The processor 204 is preferably a Hitachi SH7707 processor core, but can be any suitable processor for implementing the functionality of the test device 200.

The memory 206 can include any one or a combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 206 may incorporate electronic, magnetic, optical, and/or other types of storage media. Note that the memory 206 can have a distributed architecture, where various components are situated remote from one another, but can be accessed by the processor 204.

The software in memory 206 may include one or more separate programs, each of which comprise one or more code segments, which are an ordered listing of executable instructions for implementing logical functions. In the example of FIG. 2, the software in the memory 206 includes a base GUI software module 230 coupled to a plug-in GUI software module 240 via connection 232. The memory 206 also includes one or more operating software modules, collectively referred to as operating system (O/S) 210. The O/S 210 may include software modules that perform some of the functionality of the test device 200 not specifically described herein.

In a preferred embodiment, the O/S 210 is the commonly available Windows CE operating system. However, other operating systems may be used. The operating system 210 essentially controls the execution of other computer programs, such as the base GUI software module 230 and the plug-in GUI software module 240, and provides scheduling, input-output control, file and data management, memory management, and communication control and related services. The processor 204 and operating system 210 define a computer platform, for which application programs, such as the base GUI software module 230 and the plug-in GUI software module 240, are written in higher level programming languages. The base GUI software module 230 and the plugin GUI software module 240 include the executable instructions that allow the test device 200 to analyze and test particular aspects of the communication links described above and present such analysis to a user of the test device 200 on the display 280.

The base GUI software module 230 allows the graphical user interface provided to the user of the test device 200 via the display 280 to have a common “look and feel” between different plug-in hardware modules 250 and 260. The plug-in GUI software module 240, when loaded with the flash memory component 251 and/or the flash memory component 261 provides to a user of the test device 200 aspects specific to the individual plug-in test modules 250 and 260, but in a common GUI framework.

For example, one plug-in test module 250 may be used in cooperation with corresponding plug-in GUI software module 240 to allow the test device 200 to test different parameters of a communication channel and simultaneously display those different parameters to a user via the display 280. When the display 280 is a touch screen display allowing a user to input commands via the display 280, a user may interactively communicate with the test device 200 to view the different parameters of the communication link under test. Further, if two plug-in test modules are used in the test device 200, two communication links can simultaneously be monitored and tested allowing a user to view the same parameter of the two communication links or to view multiple parameters of multiple communication links.

The combination of the plug-in test modules 250 and 260, the base GUI software module 230 and the plug-in GUI software module 240 allows the test device 200 to display various combinations of communication link parameters depending upon the interaction of the plug-in test modules 250 and 260. The base GUI software module 230 can be thought of as the test device platform GUI software module while the plug-in GUI software module 240 can be thought of as the “module specific” GUI software.

When the test device 200 is in operation, the processor 204 is configured to execute software stored within the memory 206, to communicate data to and from the memory 206 and to generally control operations of the test device 200 pursuant to the software. The base GUI software module 230, the plug-in GUI software module 240 and the O/S 210, in whole or in part, but typically the latter, are read by the processor 204, perhaps buffered within the processor 204, and then executed.

When portions of the network test system having a multiple screen graphical user interface are implemented in software, as is shown in FIG. 2, it should be noted that the base GUI software module 230, the plug-in GUI software module 240 and the O/S 210 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The base GUI software module 230, the plug-in GUI software module 240 and the O/S 210 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the network test system having a multiple screen graphical user interface can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Furthermore, through the careful selection of components, the test device 200 can be economically manufactured in a light weight, portable, battery powered package weighing less than six (6) pounds including the plug-in test modules 250 and 260.

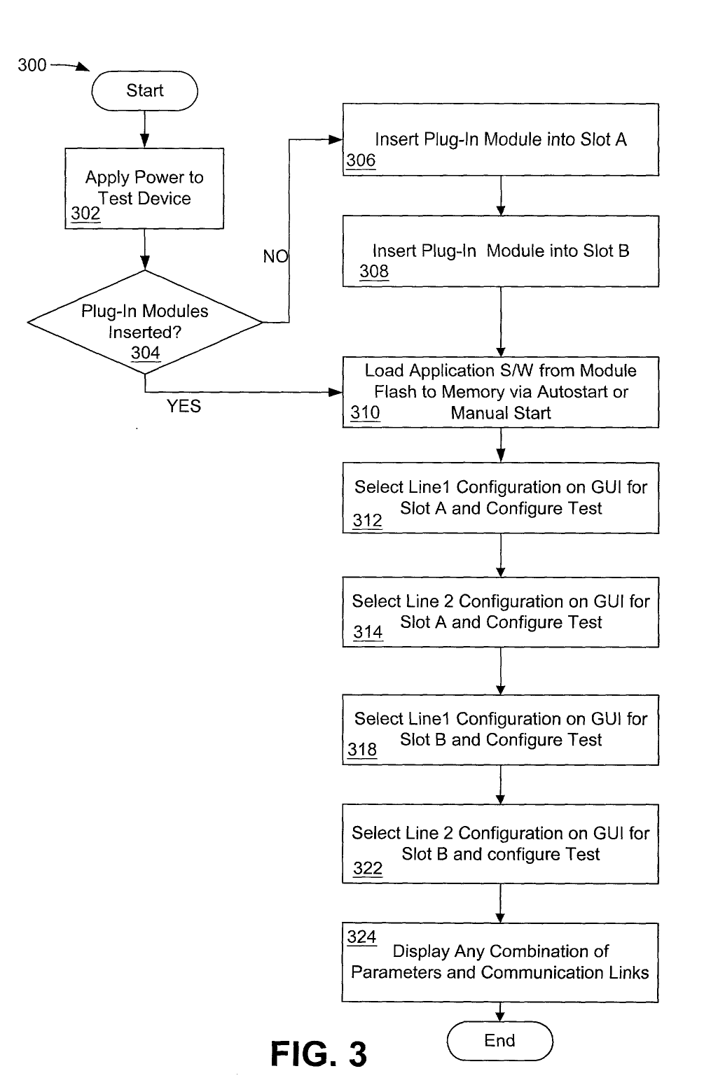

FIG. 3 is a flow chart 300 illustrating an example of the operation of one embodiment of the invention. The flow chart of FIG. 3 shows the architecture, functionality, and operation of a possible implementation of the base GUI software module 230 and the plug-in GUI software module 240 of FIG. 2. In this regard, each block represents a module, segment, or portion of code, which comprises one or more executable instructions for implementing the specified logical function(s). It should also be noted that in some alternative implementations, the functions noted in the blocks may occur out of the order noted in FIG. 3. For example, two blocks shown in succession in FIG. 3 may in fact be executed substantially concurrently or the blocks may sometimes be executed in the reverse order, depending upon the functionality involved, as will be further clarified below.

The following description illustrates a situation in which two plug-in modules (250 and 260 of FIG. 2) are mated to the test device 200 and coupled to two different communication links. However, the invention is applicable tin situations in which a fewer or greater number of plug-in modules are coupled to a fewer or greater number of communication links.

In block 302 power is applied to the test device 200 and the test device 200 is powered up. In block 304 it is determined whether one or more of the plug-in test modules 250 and/or 260 are coupled into the bus interface 208 (FIG. 2). If no plug-in test modules are coupled into the bus interface 208, then in block 306 the plug-in test module 250 is coupled into its respective slot and, if used, the plug-in test module 260 is coupled into its respective slot in the bus interface 208 in block 308. This illustrates the “hot-swap” feature of the test device 200. If one or more plug-in test modules are coupled into the test device 200 prior to the application of power, then the process moves to block 310.

In block 310 the application software that is located in the flash memory element 251 for the plug-in module 250 (and the flash memory element 261 for the plug-in module 260) is loaded into the memory 206 (FIG. 2) and forms a component of the plug-in GUI software module 240 (FIG. 2).

In block 312, a button corresponding to a configuration operation for line 1 (i.e., a first communication link to which the test device 200 is connected) is selected on the display 280 for the plug-in test module 250. Through the use of the GUI presented to the user, the plug-in test module 250 can be configured as appropriate for the functionality that it will perform.

In block 314, a button corresponding to a configuration operation for line 2 (i.e., a second communication link to which the test device 200 is connected) is selected on the display 280 for the plug-in test module 250.

In block 318, a button corresponding to a configuration operation for line 1 (i.e., the first communication link to which the test device 200 is connected) is selected on the display 280 for the plug-in test module 260 and in block 322, a button corresponding to a configuration operation for line 2 (i.e., the second communication link to which the test device 200 is connected) is selected on the display 280 for the plug-in test module 260.

Then, as shown in block 324, any combination of parameters for the first and second communication lines can be displayed simultaneously to a user.

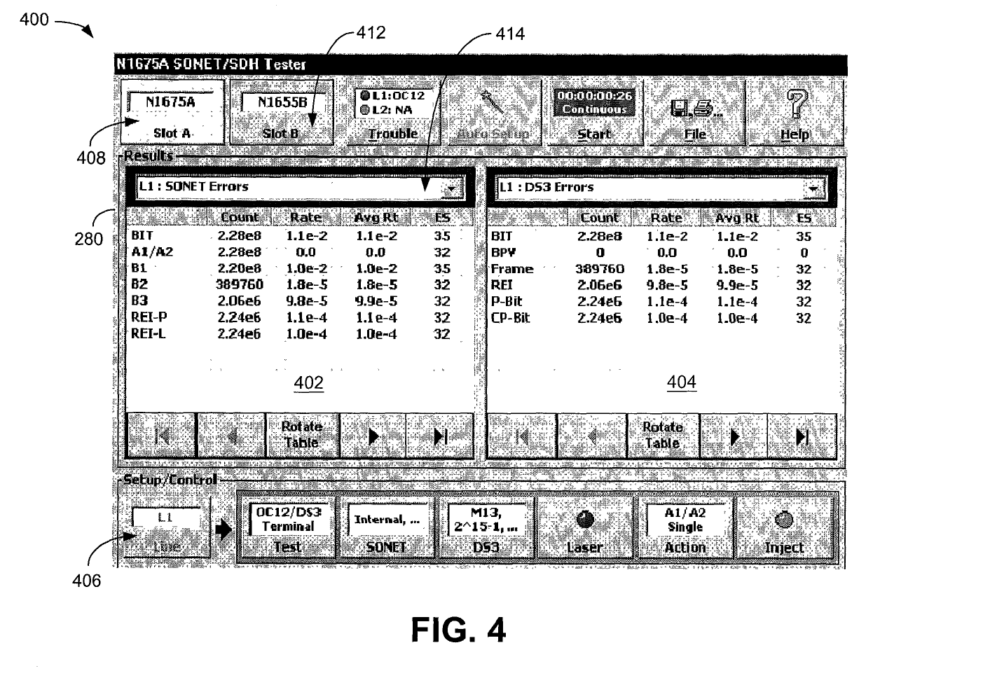

FIG. 4 is a graphical illustration showing the graphical user interface (GUI) 400 presented to a user of the test device 200 in which two different parameters are displayed for one communication line on the display 280 using different screens, or panels. As shown, the panel 402 of the screen shows the SONET errors with respect to a first communication link (line 1), while the panel 404 of the screen shows the DS-3 errors for the same communication link (line 1). In accordance with an aspect of the invention, both optical parameters (the SONET errors) and electrical parameters (DS-3 errors) are simultaneously displayed to a user of the test device 200 using the LCD touch screen display 280. Furthermore, the display 280 includes one or more touch sensitive buttons, examples of which are illustrated using reference numerals 406, 408 and 412, and pull down style menus, an example of which is illustrated using reference numeral 414, that enable a user of the test device 200 to interactively communicate with the test device 200 through the display 280. For example, a user may activate the line button 406 to switch between the two communication links being monitored. Furthermore, by activating the slot buttons 408 and 412, a user may switch between two plug-in test modules 250 and 260 (FIG. 2). Further still, other buttons on the display 280 allow a variety of test and measurement functionality to be selected by the user through the display 280.

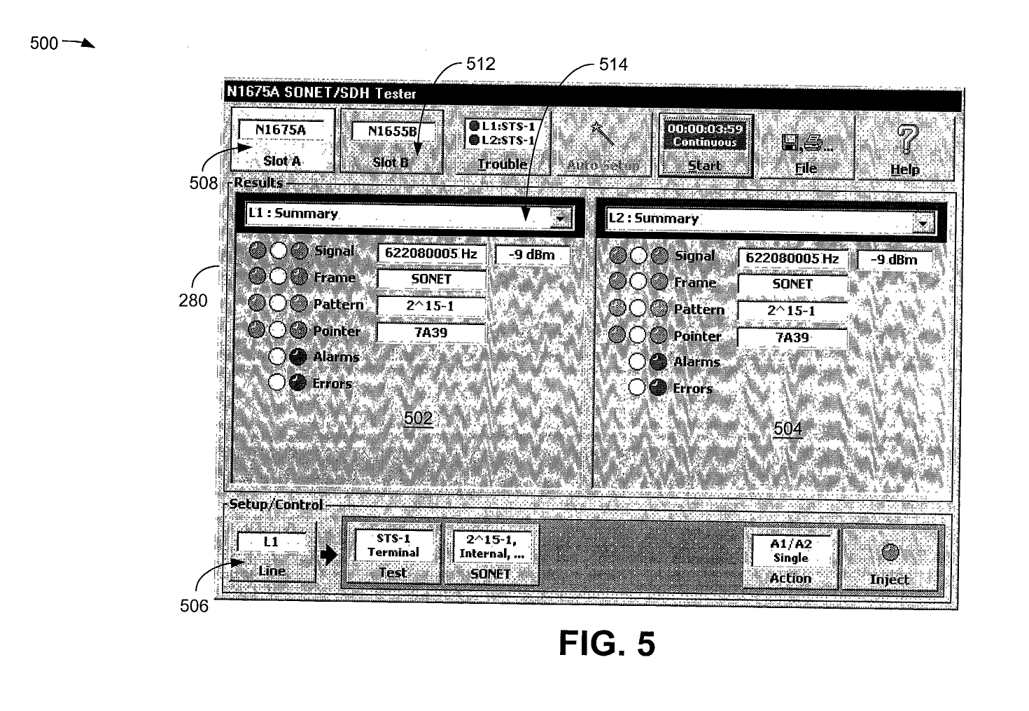

FIG. 5 is a graphical illustration showing the graphical user interface (GUI) 500 presented to a user of the test device 200 in which the same parameter for two different communication links is simultaneously displayed to a user. The graphical interface 500 illustrates parameters of a first communication line (line 1) in the panel 502 of the display 280 while the panel 504 of the display 280 includes similar parameters of a second communication link (line 2). Furthermore, the invention can be used to display only electrical parameters or only optical parameters of one or more communication lines.

It will be apparent to those skilled in the art that many modifications and variations may be made to the preferred embodiments of the present invention, as set forth above, without departing substantially from the principles of the present invention. For example, the network test system having a multiple screen graphical user interface can be used in any communication environment to simultaneously test any of a number of different communication link parameters on one or more communication links, or the same parameter on different communication links. Furthermore, while illustrated as including two panels that can display any combination of two communication lines and communication line parameters, the invention is applicable to systems including a greater or fewer number of panels. All such modifications and variations are intended to be included herein within the scope of the present invention, as defined in the claims that follow.

What is claimed is:

1. A network test device, comprising:
a base unit including at least one modular location to receive a test module;
at least one test module coupled to the base unit and configured to provide access to a communication link; and
a display configured to simultaneously display at least two communication link parameters.

2. The device of claim 1, wherein the two communication link parameters are different parameters of the same communication link.

3. The device of claim 1, further comprising an additional test module coupled to the base unit and configured to allow the display to display the same communication link parameter of two different communication links.

4. The device of claim 1, wherein the display is a touch screen display capable of allowing a user to input commands to the base unit.

5. The device of claim 1, wherein the communication link is an optical communication link and one of the two communication link parameters is an optical parameter and the other parameter is an electrical parameter.

6. The device of claim 1, wherein the communication link is an optical communication link and both of the two communication link parameters are optical parameters.

7. The device of claim 1, wherein the communication link is an optical communication link and both of the two communication link parameters are electrical parameters.

8. The device of claim 1, wherein the display further includes controls that allow a user to alternate between the at least two communication link parameters.

9. The device of claim 1, further comprising a battery powered module.

10. The device of claim 1, wherein the device weighs less than six (6) pounds.

11. The device of claim 3, wherein the display further includes controls that allow a user to alternate between the same communication link parameter of the two different communication links.

12. A method for operating a network test device, comprising:
providing a base unit including at least one modular location to receive a test module;
coupling at least one test module to the base unit, the test module configured to provide access to a communication link; and
displaying at least two communication link parameters simultaneously.

13. The method of claim 12, wherein the two communication link parameters are different parameters of the same communication link.

14. The system of claim 12, further comprising:
coupling an additional test module to the base unit; and
displaying the same communication link parameter of two different communication links.

15. The method of claim 12, further comprising inputting commands to the base unit using a touch screen display.

16. The method of claim 12, wherein the communication link is an optical communication link and one of the two communication link parameters is an optical parameter and the other parameter is an electrical parameter.

17. The method of claim 12, wherein the communication link is an optical communication link and both of the two communication link parameters are optical parameters.

18. The method of claim 12, wherein the communication link is an optical communication link both of the two communication link parameters are electrical parameters.

19. The method of claim 12, further comprising alternating the display between the at least two communication link parameters.

20. The method of claim 14, further comprising alternating the display between the same communication link parameter of the two different communication links.

21. A computer readable medium having a program for operating a network test device, the network test device including at least one modular location to receive a test module, the program comprising:
logic for coupling at least one test module to the base unit, the test module configured to provide access to a communication link; and
logic for displaying at least two communication link parameters simultaneously.

22. The program of claim 21, wherein the two communication link parameters are different parameters of the same communication link.

23. The system of claim 21, further comprising:
coupling an additional test module to the base unit; and
logic for displaying the same communication link parameter of two different communication links.

24. The system of claim 21, further comprising logic for inputting commands to the base unit using a touch screen display.

25. The system of claim 21, wherein the communication link is an optical communication link and one of the two communication link parameters is an optical parameter and the other parameter is an electrical parameter.

26. The system of claim 21, wherein the communication link is an optical communication link and both of the two communication link parameters are optical parameters.

27. The system of claim 21, wherein the communication link is an optical communication link and both of the two communication link parameters are electrical parameters.

28. The system of claim 21, further comprising logic for alternating the display between the at least two communication link parameters.

29. The system of claim 23, further comprising logic for alternating the display between the same communication link parameter of the two different communication links.
